(19) United States
(12) Patent Application Publication
(10) Pub. No.: US 2025/0354503 A1
(43) Pub. Date: Nov. 20, 2025

(54) METHOD FOR MONITORING THE STATE OF HEAT EXCHANGER PIPELINES OF A WASTE HEAT STEAM GENERATOR, AND WASTE HEAT STEAM GENERATOR

(71) Applicant: Siemens Energy Global GmbH & Co. KG, Munich, Bayern (DE)

(72) Inventors: Vitaly Malinin, Moscow (RU); Adrian Stefanescu, Erlangen (DE); Denis Tschetschik, Bubenreuth (DE)

(73) Assignee: Siemens Energy Global GmbH & Co. KG, Munich, Bayern (DE)

(21) Appl. No.: 18/854,664

(22) PCT Filed: Jan. 20, 2023
(86) PCT No.: PCT/EP2023/051427

§ 371 Date: Oct. 7, 2024

(30) Foreign Application Priority Data
Apr. 12, 2022 (DE) 10 2022 203 647.6

(51) Int. Cl. F01K 13/00

(52) U.S. Cl. CPC F01K 13/003

(57) ABSTRACT

A method for monitoring the state of pipelines, which conduct water or steam, of at least one heat exchanger, in particular a heat exchanger designed as a superheater, a heat exchanger designed as an evaporator, and a heat exchanger designed as a feed water preheater. When viewed in the downstream flow direction, the at least one heat exchanger is arranged in the exhaust gas flow of a waste heat steam generator. The presence of steam within the exhaust gas flow is automatically detected using sensors which detect a measurement variable that represents the moisture content of the exhaust gas flow and/or using an optical detection system, and if steam is detected, an alarm is triggered. A waste heat steam generator is designed to carry out the method.

### CROSS REFERENCE TO RELATED APPLICATIONS

This application is the US National Stage of International Application No. PCT/EP2023/051427 filed 20 Jan. 2023, and claims the benefit thereof, which is incorporated by reference herein in its entirety. The International Application claims the benefit of German Application No. DE 10 2022 203 647.6 filed 12 Apr. 2022.

### FIELD OF INVENTION

The invention relates to a method for monitoring the state of water- or steam-conducting tubes of at least one heat exchanger, in particular a heat exchanger serving as a superheater, a heat exchanger serving as an evaporator and a heat exchanger serving as a feedwater preheater when viewed in the downstream direction, said at least one heat exchanger being arranged in an exhaust gas flow of a heat recovery steam generator. The invention also relates to a heat recovery steam generator having an exhaust gas channel, in which at least one heat exchanger comprising water- or steam-conducting tubes is arranged, in particular a heat exchanger serving as a superheater, a heat exchanger serving as an evaporator, and a heat exchanger serving as a feedwater preheater when viewed in the downstream direction.

### BACKGROUND OF INVENTION

Heat recovery steam generators, often abbreviated as HRSGs, are known in various configurations from the prior art. They serve to utilize the hot exhaust gas from an upstream process for steam generation purposes, and usually comprise an exhaust gas channel in which a plurality of heat exchangers are arranged, when viewed in the downstream direction; these heat exchangers are usually in the form of a superheater, an evaporator and a feedwater preheater. Leaks in the tubes of the heat exchangers carrying water or steam can entail fault-related, unannounced downtimes, which should be avoided. Accordingly, it is desirable to be able to identify such leaks as early as possible in order to provide the maintenance staff with sufficient time for locating the position of a leak, determining the extent thereof, and planning and performing the repair works. In this context, acoustic detection systems have become established in the past; in these, the noise environment of a heat recovery steam generator is monitored using a multiplicity of acoustic sensors, which are positioned in a manner distributed over the entire heat recovery steam generator. Leaks cause a change in the ambient noise, and this is detected by the sensors. In this case, sensors positioned closer to the leak location detect greater changes in noise than sensors positioned further way. This also renders a sensor-based localization of a leak possible. However, a disadvantage of the known acoustic detection systems consists in the fact that several hundred sensors must be arranged and wired up in a manner distributed over the heat recovery steam generator; this is both very complicated and expensive.

Using this prior art as a starting point, a problem addressed by the present invention is that of developing an alternative method and an alternative heat recovery steam generator of the type set forth at the outset, in which the aforementioned problems in particular are reduced.

### SUMMARY OF INVENTION

To solve this problem, the present invention has developed a method for monitoring the state of water- or steam-conducting tubes of at least one heat exchanger, in particular a heat exchanger serving as a superheater, a heat exchanger serving as an evaporator and a heat exchanger serving as a feedwater preheater when viewed in the downstream direction, said at least one heat exchanger being arranged in an exhaust gas flow of a heat recovery steam generator, characterized in that the presence of steam within the exhaust gas flow is detected automatically using sensors (18) that measure a measured quantity representing the moisture content of the exhaust gas flow and/or using an optical detection system, and an alarm is triggered in the event of a detection and makes the staff aware of the leak. To detect a tube leak, the present invention consequently proposes the use of sensors that measure a measured quantity representing the moisture content of the exhaust gas flow, in particular the moisture content of the exhaust gas itself, and/or an optical detection system rather than the use of acoustic sensors. If there is a leak in a water- or steam-conducting tube, water or steam fractions flow into the exhaust gas and thus cause an increase in moisture content of the exhaust gas, which is subsequently detected by the sensors. As an alternative to that or in addition, the steam flow in the exhaust gas, which forms a steam cloud or steam swathe propagating downstream from the location of the leak, can be recognized by an optical detection system. In comparison with conventional acoustic sensors, the sensors used according to the invention most notably have the advantage that significantly fewer sensors are needed, and these need not be positioned in a manner distributed over the heat recovery steam generator but only be positioned locally within the exhaust gas channel. This entails lower costs and significantly reduced maintenance outlay. The same applies to an optical detection system.

By preference, the sensors are moisture sensors, in particular commercially available moisture sensors; this is beneficial to a simple and cost-effective technical implementation of the method according to the invention.

According to one configuration of the present invention, the measured values measured by the sensors are compared with at least one stored limit value, and the alarm is triggered if at least one of the measured values exceeds the limit value. Advantageously, the limit value defined in advance is chosen to be sufficiently high that there is reliable certainty regarding the actual presence of a leak and chosen to be sufficiently small so that there still is sufficient time remaining for the purpose of planning and carrying out repair work that rectifies the leak.

According to one configuration of the present invention, the sensors measure the measured quantity at measurement points which are arranged in distributed fashion over a cross section of the exhaust gas flow, preferably over an individual cross section of the exhaust gas flow. Firstly, such an arrangement of the sensors is advantageous to the effect that only comparatively few sensors are required, whereby the structure of the detection system is simplified, and costs are minimized. Secondly, localization of a leak is also rendered possible by such an arrangement. Knowledge regarding the flow behavior of the exhaust gas through the exhaust gas conduit and of a steam cloud or swathe carried along with the exhaust gas, which for example can be obtained within the scope of a simulation using suitable software, allows the location of the leak to be inferred on the basis of the positions and numbers of those sensors which have detected an increase in moisture content of the exhaust gas and on the basis of the increase in moisture content measured by the individual sensors. The further a leak is away from the position of the sensors in the flow direction of the exhaust gas, the more sensors arranged in a manner distributed over the cross section of the exhaust gas channel will perceive an increase in moisture content. The closer a leak is to the position of the sensors in the flow direction of the exhaust gas, the higher the increase in moisture content measured by the corresponding sensors.

By preference, the measurement points are arranged in the style of a grid in uniformly distributed fashion over the cross section of the exhaust gas flow, leading to a simple structure and reliable statements.

Advantageously, the measurement points are positioned downstream of the last heat exchanger through which the exhaust gas flow flows, in particular positioned exclusively downstream of the last heat exchanger through which the exhaust gas flow flows. A consequence of this is that the temperature of the exhaust gas in the region of the measurement points is minimal, allowing the use of cost-effective sensors as these need not have a high temperature resistance.

According to one embodiment of the present invention, in the event of an alarm, the position of a leak is calculated on the basis of a comparison of the measured values ascertained at different measurement points, and the calculated position is output to operating staff.

As an alternative to that or in addition, an optical detection system is used according to the invention for detection purposes.

According to one configuration of the present invention, the optical detection system comprises at least one video camera, with for the aforementioned reasons the at least one camera preferably being positioned downstream of the last heat exchanger through which the exhaust gas flow flows. Advantageously, the at least one video camera is directed at an inner surface of the heat recovery steam generator furnished with a predetermined pattern. If such a pattern is partly concealed by a steam cloud or swathe moving past, then this can be detected on the basis of the recorded video frames. By preference, at least two video cameras are positioned on opposite sides of the exhaust gas channel and directed on mutually opposite inner surfaces of the exhaust gas channel, whereby a better localization of the leak is rendered possible.

As an alternative to that or in addition, the optical system can comprise at least one laser, the said laser in particular being directed at an associated light detector arranged on an inner surface of the heat recovery steam generator, with the at least one laser and the associated light detector preferably being positioned downstream of the last heat exchanger through which the exhaust gas flow flows. The presence of steam in the exhaust gas flow can also be detected by the concealment of the light detector by a steam cloud or swathe. Advantageously, a cross section of the exhaust gas channel is covered by a multiplicity of laser beams that were emitted adjacently to one another and are directed at corresponding light detectors, whereby a determination of the position and size of the steam cloud or swathe, and hence a localization of the leak, is made possible.

The present invention also develops a heat recovery steam generator having an exhaust gas channel, in which at least one heat exchanger comprising water- or steam-conducting tubes is arranged, in particular a heat exchanger serving as a superheater, a heat exchanger serving as an evaporator, and a heat exchanger serving as a feedwater preheater when viewed in the downstream direction, characterized in that sensors and/or an optical detection system designed to detect the presence of steam in an exhaust gas guided through the exhaust gas channel are provided within the exhaust gas channel, and in that provision is made for a controller data-connected to the sensors and/or to the optical detection system and configured to carry out the method according to the invention.

By preference, the sensors are moisture sensors.

Advantageously, provision is made of a holding grid extending over a cross section of the exhaust gas channel and accommodating the sensors, with the sensors being positioned at regular intervals on the holding grid in particular. Such a holding grid ensures a simple and cost-effective installation of the sensors over the cross section of the exhaust gas channel.

By Preference, the Holding Grid is Arranged Downstream of the Last Heat Exchanger.

Advantageously, the optical detection system comprises at least one camera and/or at least one laser. The at least one camera and the at least one laser can be positioned in the exhaust gas channel as already described previously in the context of the method according to the invention.

Further features and advantages of the present invention will become clear on the basis of the following description which makes reference to the attached drawing.

### BRIEF DESCRIPTION OF THE DRAWINGS

In the drawing:

FIG. 1 shows a schematic side view of a heat recovery steam generator according to one embodiment of the present invention;

FIG. 2 shows a sectional view along the line II-II in FIG. 1;

FIG. 3 shows a view analogous to FIG. 1, which schematically shows damage to tubes of different heat exchangers in the heat recovery steam generator and steam clouds resulting therefrom;

FIG. 4 shows a sectional view along the line IV-IV in FIG. 3; and

FIG. 5 shows a schematic plan view of a downstream region of a heat recovery steam generator according to a further embodiment of the present invention.

### DETAILED DESCRIPTION OF INVENTION

Hereinafter, the same reference signs denote the same or similar parts or components.

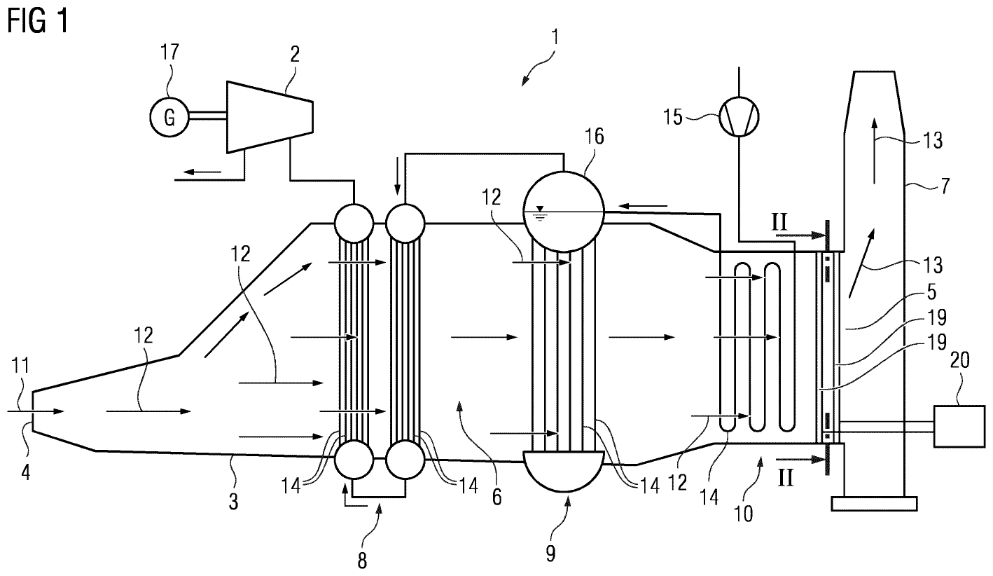

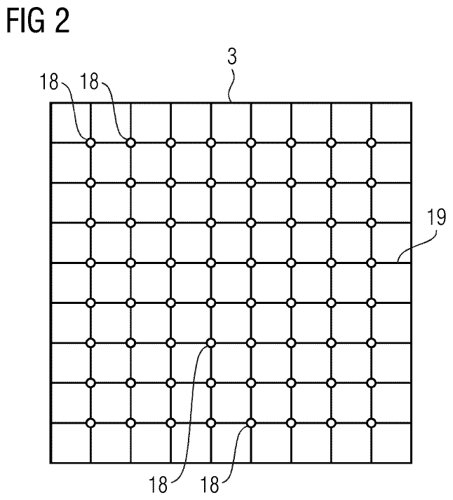

FIG. 1 shows a heat recovery steam generator 1 according to one embodiment of the present invention, which in a known manner serves the generation of superheated steam from feedwater by using hot exhaust gas of an upstream process, and this superheated steam is used to drive a steam turbine 2.

The heat recovery steam generator 1 comprises a housing 3, through which an exhaust gas channel 6 having an exhaust gas inlet 4 and an exhaust gas outlet 5 extends; via a diffuser, said exhaust gas channel opens into a downstream chimney 7. In the flow direction of the exhaust gas, three heat exchangers 8, 9 and 10 are arranged in succession within the exhaust gas channel 6 in the present case, with the heat exchanger 8 serving as a superheater, the heat exchanger 9 serving as an evaporator and the heat exchanger 10 serving as a feedwater preheater.

During the operation of the heat recovery steam generator 1, hot exhaust gas from an upstream process, for example the hot exhaust gas from a gas turbine process, is introduced through the exhaust gas inlet 4 into the exhaust gas channel 6 in the direction of the arrow 11. The exhaust gas flows through the exhaust gas channel 6 in the direction of the arrows 12, enters the chimney 7 through the exhaust gas outlet 5, flows through said chimney in the direction of the arrows 13 and is ultimately released into the surroundings. On its path through the exhaust gas channel 6, the exhaust gas dissipates heat to feedwater guided through tubes 14 of the heat exchangers 8, 9 and 10 in counter flow in order to superheat said feedwater in stages. In more detail, feedwater supplied to the heat exchanger 10 positioned at the downstream end of the exhaust gas channel 6 via a feedwater pump 15 is initially preheated by the exhaust gas. The preheated feedwater is then supplied to a steam drum 16, which feeds the tubes 14 of the heat exchanger 9 with the preheated feedwater. The feedwater is then evaporated in the heat exchanger 9. The steam created is subsequently supplied to the tubes 14 of the heat exchanger 8, where it is superheated. The superheated steam is subsequently guided to the steam turbine 2, which for example drives a generator 17.

It is desirable to monitor the state of the tubes 14 of the heat exchangers 8, 9 and 10 during the operation of the heat recovery steam generator, in order to detect possibly arising leaks as early as possible and thus minimize downtime and maintenance times.

For the purpose of monitoring the state of the tubes 14, the heat recovery steam generator 1 of the present embodiment comprises a multiplicity of sensors 18 which are arranged within the exhaust gas channel 6 and which are designed to measure a measured quantity representing the moisture content of the exhaust gas flow. In the present case, the sensors 18 are embodied as moisture sensors and positioned in such a way that they measure the moisture content of the exhaust gas flow, which is guided through the exhaust gas channel 6, at a multiplicity of measurement points. As an alternative to that or in addition, it is also possible to use sensors that do not measure the moisture content directly but for example instead measure a measured quantity that is proportional to the moisture content. In the depicted embodiment, the sensors 18 are provided on a holding grid 19 which extends over a cross section of the exhaust gas channel. In this case, the sensors 18 are positioned in the style of a matrix at regular intervals on the holding grid 19. The holding grid 19 is arranged downstream of the last heat exchanger 10 such that the sensors 18 measure the moisture content of the exhaust gas after the latter has passed through all heat exchangers 8, 9 and 10. In principle, further holding grids 19 with sensors 18 attached thereto can be provided within the exhaust gas channel 6 in order to measure the moisture content of the exhaust gas at various cross sections of the exhaust gas channel 6. In the present case, a second holding grid with sensors 18 held thereon is positioned downstream of the first holding grid 19, with the intention being that these sensors 18 merely verify the measurement values measured by the sensors 18 positioned upstream and thus form a redundant arrangement. The sensors 18 are data-coupled to a controller 20.

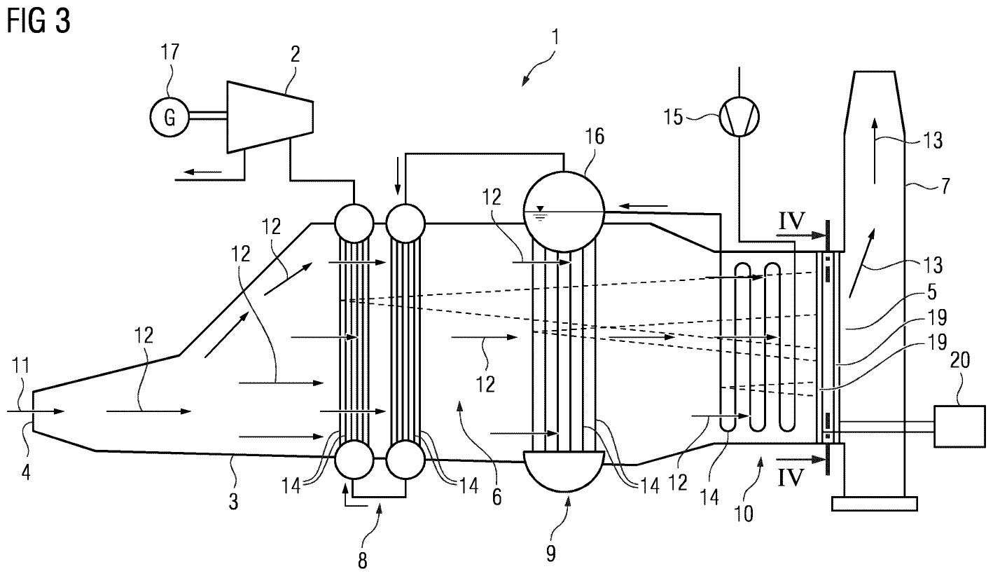

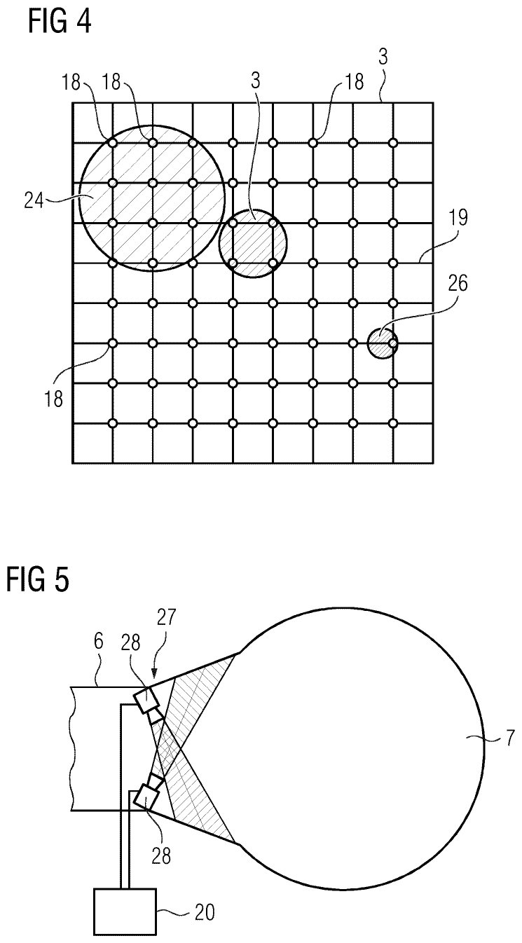

FIGS. 3 and 4 schematically show instances of damage 21, 22 and 23 to a respective tube 14 of the three heat exchangers 8, 9 and 10. The instances of damage 21 lead to water or steam emerging from the tubes 14, being carried along by the hot exhaust gas and forming steam clouds in the process, whereby the moisture content of the exhaust gas increases. It has transpired that the region over which the sensors 18 detect an increase in moisture content of the exhaust gas increases with increasing distance between the instances of damage 21, 22, 23 and the sensors 18 since the steam is distributed more and more in a manner proportional to the distance traveled within the exhaust gas channel 6; this is indicated schematically by the dashed lines in FIG. 3 and by the circles 24, 25 and 26 of different size in FIG. 4. In this case, the circle 24 sketches out the region in which the sensors 18 record an increase in moisture content of the exhaust gas caused by the damage 21, the circle 25 sketches out the region in which the sensors 18 record an increase in moisture content of the exhaust gas caused by the damage 22 and the circle 26 sketches out the region in which the sensors 18 record an increase in moisture content of the exhaust gas caused by the damage 23. It has also transpired that the intensity of the increase in moisture content of the exhaust gas increases with decreasing distance between the damage 21, 22, 23 and the sensors 18; in FIG. 4, this is indicated by the denseness of the hatching of the circles 24, 25, 26. Using the position and number of sensors 18 registering an increase in moisture content of the exhaust gas and using the registered level of increase in moisture content of the exhaust gas, it is possible to correspondingly infer the position of the leak, facilitating the maintenance staff's search for the leak and minimizing the maintenance duration.

The sensors 18 measure the moisture content of the exhaust gas at predetermined intervals or continuously during the operation of the heat recovery steam generator 1. The measured values that were measured are then transmitted to the controller 20, where the measured values that were measured are compared with at least one stored limit value. The at least one limit value can be a fixed limit value which was defined in a manner depending on the operating conditions, for example the external temperature, the humidity, the type of fuel used in the upstream process, etc. In an alternative to that or in addition, however, the limit value might also be defined, for example, as a maximal admissible increase in moisture content of the exhaust gas within a predetermined time period. An alarm is triggered should at least one of the measured values that were measured exceed the at least one limit value, in order to draw the operating staff's attention to the detected leak. Further, the position of the leak is calculated, and this is output for the operating staff. The measured values measured by the sensors 18 arranged on the rear holding grid 19 in the flow direction of the exhaust gas are used to verify the measured values measured by the sensors 18 arranged on the front holding grid 19, in order to thus minimize false alarms and/or adopt the function of failed sensors 18 on the first holding grid 19.

Monitoring the state of water- or steam-conducting tubes 14 in a manner according to the invention is distinguished in that the number of sensors can be reduced significantly in comparison with conventional acoustic monitoring, whereby costs are saved. Arranging the sensors 18 at the downstream end of the heat recovery steam generator 1 allows the use of cost-effective commercially available sensors 18 since the exhaust gas temperature is comparatively low there and located within the admissible temperature range of cost-effective commercially available sensors. The sought-after monitoring accuracy can also be attained using cost-effective commercially available sensors. It has transpired that, in relation to the mass flow flowing through a tube 14, a 1% leak rate caused by damage 21 to a tube 14 of the first heat exchanger 8 and leading to an emerging steam mass flow of approximately 2 g/s entails a 2-2.5% increase in the moisture content of the exhaust gas immediately downstream of the first heat exchanger 8 and a 1-1.5% increase in the moisture content of the exhaust gas immediately downstream of the third heat exchanger 10 and accordingly at the position of the sensors 18; this can be measured by cost-effective commercially available moisture sensors.

FIG. 5 shows a detail of a heat recovery steam generator 1 according to a further embodiment of the present invention, the structure of which fundamentally corresponds to the structure of the first embodiment. However, instead of the sensors 18, an optical detection system 27 is provided here; in the present case, it comprises two video cameras 28 which are preferably cooled in order to be protected from the hot environment. In the depicted embodiment, the video cameras 27 are positioned on opposite sides of the exhaust gas channel 6 and are each directed at inner sides of the exhaust gas channel 6 that are provided with a predetermined pattern in the present case, for example with a pattern in the form of mesh lines. The video cameras and the patterns can be positioned at different levels in the exhaust gas channel 6, but this is not mandatory.

If regions of the patterns are concealed by a steam cloud in the case of a leak, then this is registered by image recognition software contained in the controller 20, and an alarm is triggered. The position of the leak is calculated on the basis of the size and position of the concealed pattern regions and output to the operating staff.

Attention is drawn to the fact that the optical detection system 27 may also comprise lasers with associated light detectors positioned at the inner walls of the exhaust gas channel 6 as an alternative or in addition to the video cameras 27, even if this is not depicted in the present case. In this case, the presence of a steam cloud in the exhaust gas flow is detected when the incidence of the laser light on the light detectors is attenuated or interrupted by a steam cloud. It is also possible to calculate the position of the leak in the case of a suitable choice of the positions of lasers and light detectors.

Even though the invention is illustrated and described more closely in detail by way of the preferred exemplary embodiment, the invention is not limited by the disclosed examples, and a person skilled in the art is able to derive other variations therefrom, without departing from the scope of protection of the invention.

1. A method for monitoring a state of water- or steam-conducting tubes of at least one heat exchanger, said at least one heat exchanger being arranged in an exhaust gas flow of a heat recovery steam generator, comprising:
detecting a presence of steam within the exhaust gas flow automatically using sensors that measure a measured quantity representing a moisture content of the exhaust gas flow and/or using an optical detection system, and
triggering an alarm based on a detection of the presence of steam.

2. The method as claimed in claim 1,
wherein the sensors are moisture sensors.

3. The method as claimed in claim 2,
wherein the measured values measured by the sensors are compared with at least one stored limit value, and the alarm is triggered if at least one of the measured values exceeds the limit value.

4. The method as claimed in claim 2,
wherein the sensors measure the measured quantity at measurement points which are arranged in distributed fashion over a cross section of the exhaust gas flow.

5. The method as claimed in claim 4,
wherein the measurement points are arranged in a style of a grid in uniformly distributed fashion over the cross section of the exhaust gas flow.

6. The method as claimed in claim 4,
wherein the measurement points are positioned downstream of the last heat exchanger through which the exhaust gas flow flows.

7. The method as claimed in claim 4,
wherein in the event of detecting the alarm, a position of a leak is calculated on a basis of a comparison of the measured values ascertained at different measurement points, and the calculated position is output.

8. The method as claimed in claim 1,
wherein the optical system comprises at least one video camera.

9. The method as claimed in claim 1,
wherein the optical detection system comprises at least one laser.

10. A heat recovery steam generator comprising:
an exhaust gas channel, in which at least one heat exchanger comprising water- or steam-conducting tubes is arranged,
sensors and/or an optical detection system designed to detect the presence of steam in an exhaust gas guided through the exhaust gas channel provided within the exhaust gas channel, and
a controller data-connected to the sensors and/or to the optical detection system and configured to carry out the method as claimed in claim 1.

11. The heat recovery steam generator as claimed in claim 10,
wherein the sensors are moisture sensors.

12. The heat recovery steam generator as claimed in claim 10, further comprising:
a holding grid accommodating the sensors provided over a cross section of the exhaust gas channel, and positioned at regular intervals on the holding grid.

13. The heat recovery steam generator as claimed in claim 12,
wherein the holding grid is arranged downstream of the last heat exchanger.

14. The heat recovery steam generator as claimed in claim 10,
wherein the optical detection system comprises at least one video camera and/or at least one laser.

15. The method as claimed in claim 1,
wherein the heat exchanger comprises as a superheater, an evaporator, and a feedwater preheater when viewed in a downstream direction.

16. The method as claimed in claim 6,
wherein the measurement points are positioned exclusively downstream of the last heat exchanger through which the exhaust gas flow flows.

17. The method as claimed in claim 8,
wherein the video camera is directed at an inner surface of the heat recovery steam generator furnished with a predetermined pattern, and/or is positioned downstream of the last heat exchanger through which the exhaust gas flow flows.

18. The method as claimed in claim 9,
wherein the at least one laser is directed at an associated light detector arranged on an inner surface of the heat recovery steam generator, and/or wherein the at least one laser and the associated light detector are positioned downstream of the last heat exchanger through which the exhaust gas flow flows.

19. The heat recovery steam generator as claimed in claim 10,
wherein the heat exchanger comprises as a superheater, an evaporator, and a feedwater preheater when viewed in a downstream direction.
